(19) United States
(12) Patent Application Publication
(10) Pub. No.: US 2003/0030633 A1
(43) Pub. Date: Feb. 13, 2003

(54) Driving method for a power-saving Liquid Crystal Display

(75) Inventors: Hsien-Ying Chou, Hsinchu (TW); Chun-Chin Tseng, Changhua Hsien (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/052,623

(22) Filed: Jan. 18, 2002

(30) Foreign Application Priority Data
Aug. 10, 2001 (TW) 90119604

(51) Int. Cl. G09G 5/00

(52) U.S. Cl. 345/212

(57) ABSTRACT

The invention provides A power-saving Liquid Crystal Display (LCD) driving method, which does not drive the non-display region on an LCD display panel to save power. The driving method includes the steps: separating the display and non-display zones on a LCD display panel; stopping supply of external power and signal to the non-display zones and actively driving the LCD. The LCD driving step includes determining whether or not the lamp lighting the non-display zone on the LCD panel is active through a regulator and/or whether the LCD display matrix circuit powering the non-display zone on the LCD panel is active through a timing controller.

### BACKGROUND OF THE INVENTION

1. Field of the Invention

The invention relates to a display panel driving method, regionicularly to A power-saving Liquid Crystal Display (LCD) driving method, which does not drive the non-display region on an LCD display panel, thus saving power.

2. Description of the Related Art

Typical, an LCD is driven in full frame. In FIG. 1, a typical driving structure includes a display panel 10, a power supply 11, and a lamp 12. The display panel 10 includes a gate driver 101, a source driver 102, and an LCD display matrix circuit 103. The number of lamps depends on the size of the display matrix circuit, and is not limited, although in FIG. 1, for the sake of clarity, an example with 3 lamps LED1-LED3 is shown. In FIG. 1, when the LCD display matrix circuit 103 displays time, power supply 11 concurrently signals the lamps LED1-LED3, the gate driver 101, and the source driver 102 to drive the full frame of the LCD display matrix circuit 103. This method wastes power. In this example of displaying time, power needs only to be supplied to the middle active zone on the frame, rather than the full frame. As such, power is saved and the display still functions normally.

### SUMMARY OF THE INVENTION

Accordingly, an object of the invention is to provide A power-saving LCD driving method which does not drive the non-display region on an LCD display panel, thus saving power.

The invention is A power-saving LCD driving method, separating the display and non-display zones on a LCD display panel, with a control circuit used to stop driving the non-display zone, thereby saving power. The driving method includes the steps of separating the display and non-display zones on a LCD display panel; stopping supply of external power and signal to the non-display zones and actively driving the LCD. The LCD driving step includes determining whether or not the lamp lighting the non-display zone on the LCD panel is active through a regulator and/or whether the LCD display matrix circuit powering the non-display zone on the LCD panel is active through a timing controller.

### BRIEF DESCRIPTION OF THE DRAWINGS

The aforementioned objects, features and advantages of this invention will become apparent by referring to the following detailed description of a preferred embodiment with reference to the accompanying drawings, wherein:

FIG. 1 is a schematic diagram of a typical LCD driving structure;

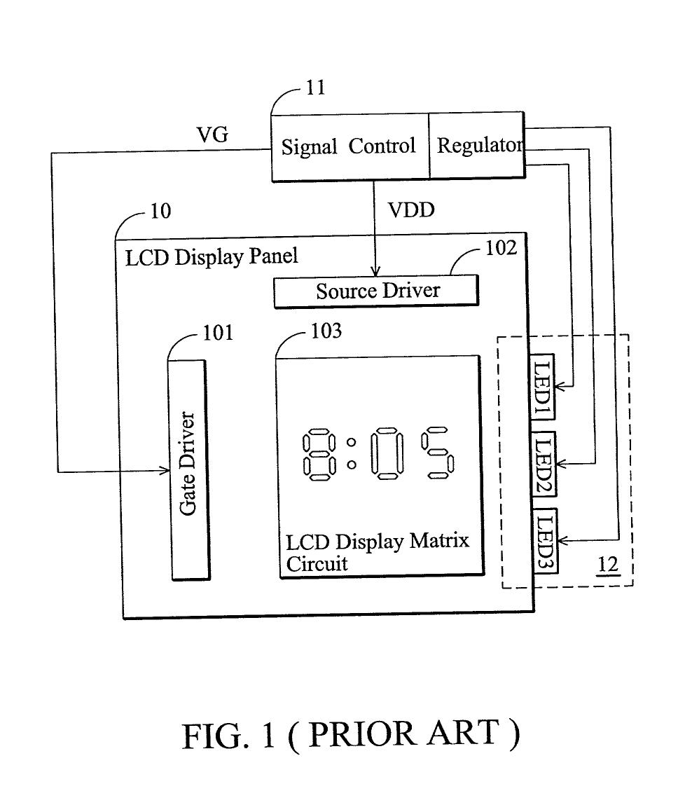

FIG. 2 is a schematic diagram of an embodiment of a LCD driving structure according to the invention;

FIG. 3 is a schematic diagram of another embodiment of the LCD driving structure according to the invention; and

FIG. 4 is a flowchart of the inventive method.

### DETAILED DESCRIPTION OF THE INVENTION

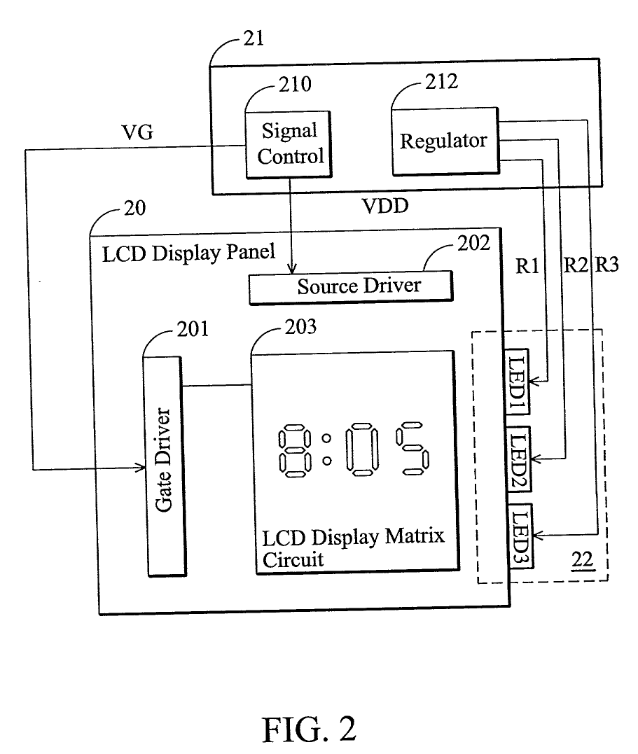

FIG. 2 is a schematic diagram of an embodiment of a LCD driving structure according to the invention. In FIG. 2, in addition to the typical LCD driving structure including a lamp 22 and a display panel 20, which has a gate driver 201, a source driver 202, and an LCD display matrix circuit 230, the structure also includes a control panel 21 to control the functions of the display panel 20 and the lamp 22. The control panel 21 includes a timing controller 210 and a regulator 212.

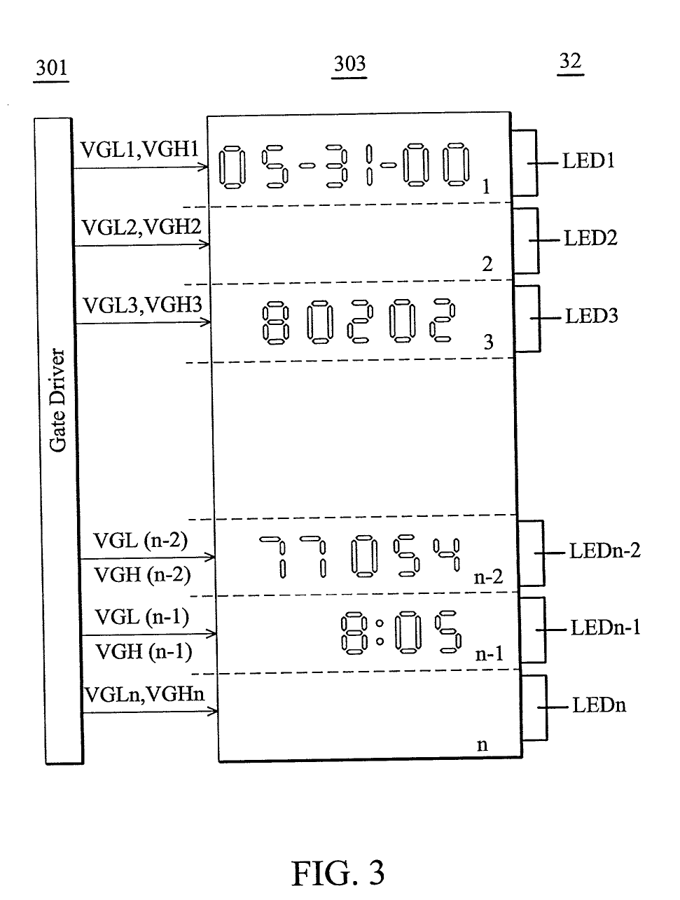

As shown in FIG. 2, for the purpose of the display and non-display zone control, a control panel is added to form the inventive structure. The system, for example, a CPU or an OS (not shown), first separates display zones and non-display zones on a display panel. For example, this display in FIG. 2 is divided into three regions; the middle region with digits is a display zone while the other two blank regions are non-display zones. Because the middle display region is controlled by the second lamp LED2 of FIG. 2, the system signals the regulator 212 and the regulator 212 enables the signal R2 to be active so as to light the lamp LED2 only. The signals R1, R3 are inactive. Therefore, power is saved. Additionally, power can be saved through the LCD display matrix circuit. At this point, the gate driver receives a control signal VG generated by the signal controller 210, so as to provide power VDD to the middle region with digits on the matrix circuit 203 while the remaining blank regions are not supplied power, thus also saving power. Compared to the efficiency of the two The power-saving types, the lamp management type is better. Both are used at the same time to achieve the most The power-saving efficiency. That is, the lamp 22 on/off and the voltage source supply to the matrix circuit 203 are controlled concurrently. Further, if a plurality of display zones are used, as shown in FIG. 3, the plurality of display zones with respect to the zones 1, 3, n−2 and n−1 can be powered through the corresponding lamps LED1, LED3, LEDn−2, and LEDn−1. Alternately, the plurality of display zones can be powered through the gate driver 301 using the corresponding voltage control signals VGL1 or VGH1, VGL3 or VGH3, VGLn−2 or VGHn−2, VGLn−1 or VGHn−1 generated by the signal controller 210. In this example, the high voltage value VGH can be, for example, +15V and the low voltage value VGL can be, for example, −12V. The high and low voltages can be changed as carried out.

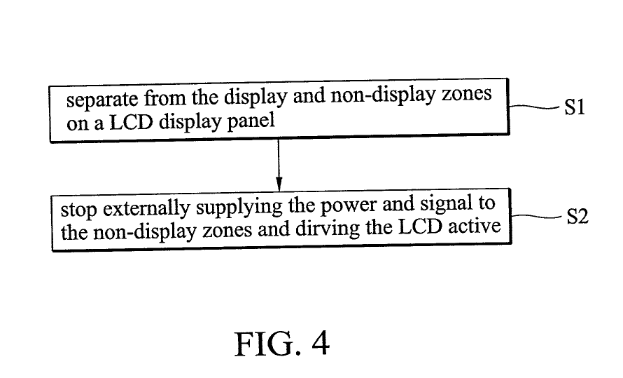

FIG. 4 is a flowchart of the inventive method. In FIG. 4, the summary mentioned above is given. As shown in FIG. 4, The power-saving Liquid Crystal Display (LCD) driving method includes the steps: separating the display and non-display zones on a LCD display panel (S1); stopping supply of external power and signal to the non-display zones and actively driving the LCD (S2). The LCD driving step includes determining whether or not the lamp lighting the non-display zone on the LCD panel is active through a regulator and/or whether the LCD display matrix circuit powering the non-display zone on the LCD panel is active through a timing controller.

Although the present invention has been described in its preferred embodiment, it is not intended to limit the invention to the precise embodiment disclosed herein. Those who are skilled in this technology can still make various alterations and modifications without deregioning from the scope and spirit of this invention. Therefore, the scope of the present invention shall be defined and protected by the following claims and their equivalents.

What is claimed is:

1. A power-saving Liquid Crystal Display (LCD) driving method, characterized in that after separating the display and non-display zones on a LCD display panel, the external power supply to the portion of the lamp lighting the non-display zones is stopped and the LCD remains active.

2. The power-saving Liquid Crystal Display driving method of claim 1, wherein there is at least one display zone.

3. The power-saving Liquid Crystal Display driving method of claim 1, wherein there is at least one non-display zone.

4. The power-saving Liquid Crystal Display driving method of claim 1, wherein a regulator is used to adjust power externally supplied to the lamp lighting the non-display zone.

5. The power-saving Liquid Crystal Display driving method of claim 4, wherein the output of the regulator is a control signal for determining if the lamp is active.

6. A power-saving Liquid Crystal Display driving method, characterized in that after separating the display and non-display zones on a LCD display panel, the external signal supply to the portion of the LCD display matrix circuit powering the non-display zones is stopped and the LCD is active.

7. The power-saving Liquid Crystal Display driving method of claim 6, wherein there is at least one display zone.

8. The power-saving Liquid Crystal Display driving method of claim 6, wherein there is at least one non-display zone.

9. The power-saving Liquid Crystal Display driving method of claim 6, wherein a signal controller is used to adjust the signal externally supplied to the LCD display matrix circuit powering the non-display zone.

10. The power-saving Liquid Crystal Display driving method of claim 9, wherein the output of the signal controller is a control signal for determining if the LCD display matrix circuit is active.

11. A power-saving Liquid Crystal Display driving method, characterized in that after separating the display and non-display zones on a LCD display panel, the external power and signal supply to the portion of the lamp and LCD display matrix circuit are stopped, respectively, with respect to the non-display zones, and the LCD is active.

12. The power-saving Liquid Crystal Display driving method of claim 11, wherein there is at least one display zone.

13. The power-saving Liquid Crystal Display driving method of claim 11, wherein there is at least one non-display zone.

14. The power-saving Liquid Crystal Display driving method of claim 11, wherein a signal controller is used to control whether or not the external power is supplied to the LCD display matrix circuit.

15. The power-saving Liquid Crystal Display driving method of claim 14, wherein the output of the signal controller is a control signal for determining if the LCD display matrix circuit is active.

16. The power-saving Liquid Crystal Display driving method of claim 11, wherein a regulator is used to adjust power externally supplied to the lamp lighting the non-display zone.
